(19) United States
(12) Patent Application Publication
(10) Pub. No.: US 2020/0081366 A1
(43) Pub. Date: Mar. 12, 2020

(54) TRANSFER DEVICE AND IMAGE FORMING APPARATUS

(71) Applicant: FUJI XEROX CO., LTD., Tokyo (JP)

(72) Inventors: Masahiro KATAHIRA, Kanagawa (JP); Yoko MIYAMOTO, Kanagawa (JP)

(73) Assignee: FUJI XEROX CO., LTD., Tokyo (JP)

(21) Appl. No.: 16/285,244

(22) Filed: Feb. 26, 2019

(30) Foreign Application Priority Data
Sep. 6, 2018 (JP) 2018-167020

(51) Int. Cl. G03G 15/02; G03G 21/20

(52) U.S. Cl. CPC G03G 15/0233; G03G 2215/021; G03G 21/206; G03G 15/0258

(57) ABSTRACT

A transfer device includes a transfer unit that transfers an image on an image carrier carrying the image onto a recording material by applying a voltage containing an alternating-current component to the recording material; a humidifying unit that humidifies the recording material transported toward the transfer unit; a transport unit that transports the recording material from the humidifying unit to the transfer unit while guiding the recording material in contact with a guide unit; and a leakage suppressing unit that suppresses leakage of an alternating current of the alternating-current component to the guide unit throughout a maximum length or more of the recording material in a direction in which the recording material is transported.

### CROSS-REFERENCE TO RELATED APPLICATIONS

This application is based on and claims priority under 35 USC 119 from Japanese Patent Application No. 2018-167020 filed Sep. 6, 2018.

### BACKGROUND

### (i) Technical Field

The present disclosure relates to a transfer device and an image forming apparatus.

### (ii) Related Art

Conventionally, a transfer device that transfers an image by applying a transfer voltage to a recording material and an image forming apparatus including such a transfer device are known.

For example, Japanese Unexamined Patent Application Publication No. 2005-164919 discloses an image forming apparatus that humidifies a surface of a transfer material on which a toner image is not transferred.

For example, Japanese Unexamined Patent Application Publication No. 2012-42827 discloses a transfer device that transfers a toner image on an image carrier onto a recording material at a transfer nip position by applying a transfer bias that is a superimposed bias in which a direct-current component and an alternating-current component are superimposed on each other.

### SUMMARY

Aspects of non-limiting embodiments of the present disclosure relate to improving transfer performance as compared with a case where there is no alternating-current leakage suppressing unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transfer device including a transfer unit that transfers an image on an image carrier carrying the image onto a recording material by applying a voltage containing an alternating-current component to the recording material; a humidifying unit that humidifies the recording material transported toward the transfer unit; a transport unit that transports the recording material from the humidifying unit to the transfer unit while guiding the recording material in contact with a guide unit; and a leakage suppressing unit that suppresses leakage of an alternating current of the alternating-current component to the guide unit throughout a maximum length or more of the recording material in a direction in which the recording material is transported.

### BRIEF DESCRIPTION OF THE DRAWINGS

An exemplary embodiment of the present disclosure will be described in detail based on the following figures, wherein:

FIG. 1 schematically illustrates a configuration of a printer that is an exemplary embodiment of an image forming apparatus according to the present disclosure;

FIG. 2 illustrates a structure for applying a voltage to a second transfer unit;

FIG. 3 is a graph illustrating a transfer voltage having a sinusoidal waveform;

FIG. 4 is a graph illustrating a transfer voltage having a rectangular waveform;

FIG. 5 is a graph illustrating another example of a transfer voltage having a rectangular waveform;

FIG. 6 illustrates a structure of a humidifier;

FIG. 7 illustrates an effect obtained in a case where an alternating-current bias is used without back-surface humidification;

FIG. 8 illustrates an effect obtained in a case where back-surface humidification is performed and an alternating-current bias is used;

FIG. 9 illustrates a structure of a transport path;

FIG. 10 illustrates a detailed structure of a back-surface guide plate;

FIG. 11 illustrates a modification of a back-surface guide plate;

FIG. 12 illustrates a modification of a humidifier;

FIG. 13 illustrates another modification of a humidifier;

FIG. 14 illustrates a non-contact-type humidifier;

FIG. 15 illustrates a modification that is different in terms of a measure for suppressing leakage of an alternating current;

FIG. 16 illustrates another modification that is different in terms of a measure for suppressing leakage of an alternating current; and

FIG. 17 illustrates still another modification that is different in terms of a measure for suppressing leakage of an alternating current.

### DETAILED DESCRIPTION

An exemplary embodiment of the present disclosure is described below with reference to the drawings.

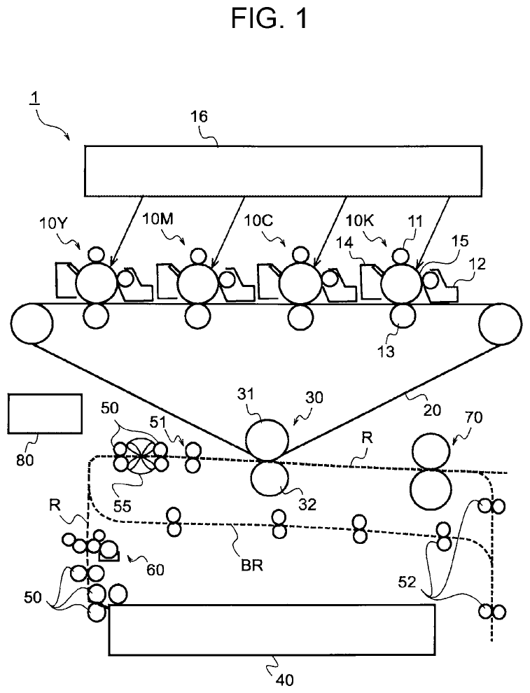

FIG. 1 schematically illustrates a configuration of a printer that is an exemplary embodiment of an image forming apparatus according to the present disclosure.

A printer 1 is a tandem-system color printer and includes four image engines 10Y, 10M, 10C, and 10K that form toner images of respective four colors (Y, M, C, and K). Furthermore, the printer 1 includes an exposure unit 16 common to these four image engines 10Y, 10M, 10C, and 10K.

Each of the image engines 10Y, 10M, 10C, and 10K forms a toner image, for example, according to an electrophotographic system. Each of the image engines 10Y, 10M, 10C, and 10K has a structure in which a charging unit 11, a developing unit 12, a first transfer unit 13, and a cleaner 14 are disposed in this order around a cylindrical photo conductor 15. In each of the image engines 10Y, 10M, 10C, and 10K, charging, exposure, and development are sequentially performed on the photo conductor 15 by the charging unit 11, the exposure unit 16, and the developing unit 12, respectively. In this way, toner images of the colors corresponding to the image engines 10Y, 10M, 10C, and 10K are formed on the photo conductors 15.

The printer 1 includes an intermediate transfer belt 20 that circulates while passing the image engines 10Y, 10M, 10C, and 10K, and the toner images of the respective colors formed by the image engines 10Y, 10M, 10C, and 10K are transferred onto the intermediate transfer belt 20 by the first transfer units 13 so as to be superimposed on one another. The cleaner 14 removes toner, paper powder, and the like remaining on the photo conductor 15 after the transfer.

The toner images of the respective colors transferred onto the intermediate transfer belt 20 are superimposed on one another so as to form a color image on the intermediate transfer belt 20. The color image on the intermediate transfer belt 20 is transported to a second transfer unit 30 by circulating movement of the intermediate transfer belt 20.

A paper tray 40 in which sheets of paper that are one kind of recording material are stored so as to be superimposed on one another is provided below the printer 1. For example, any sheets of paper selected from among plain paper having a flat surface, cardboards thicker than plain paper and having a flat surface, and embossed paper thicker than plain paper and having an uneven surface are stored in the paper tray 40. The kind of sheets of paper stored in the paper tray 40 is registered in a controller 80 that controls the whole printer 1.

A sheet of paper is extracted from the paper tray 40 by transport rollers 50 and is fed upward along a transport path R. A humidifier 60 that is an example of a humidifying unit according to the present disclosure is disposed on the transport path R and gives moisture to a back surface of the sheet of paper opposite to a front surface on which an image is to be formed.

The sheet of paper whose back surface has been moisturized is transported further upward on the transport path R and is fed to register rollers 51 by the transport rollers 50.

In the printer 1, a blower fan 55 that is an example of an air blower according to the present disclosure is provided adjacent to the transport path R. The blower fan 55 blows air from a far side to a near side in FIG. 1 and dries the transport path R by prompting evaporation of moisture remaining on the transport path R.

The register rollers 51 feed the sheet of paper to the second transfer unit 30 in synchronization with a timing at which the color image on the intermediate transfer belt 20 reaches the second transfer unit 30. The second transfer unit 30 transfers, onto the sheet of paper, the color image on the intermediate transfer belt 20 by applying a voltage while sandwiching the sheet of paper between a backup roller 31 and a transfer roller 32. The intermediate transfer belt 20 is an example of an image carrier according to the present disclosure.

The sheet of paper onto which the image has been transferred is further transported on the transport path R and is fed to a fixing unit 70 that is an example of a fixing unit according to the present disclosure. The fixing unit 70 fixes the image on the sheet of paper onto the sheet of paper by applying heat and pressure to the sheet of paper.

The sheet of paper onto which the image has been fixed is delivered to an outside of the printer 1 in a case of single-side printing in which an image is formed only on a single surface of the sheet of paper. Meanwhile, in a case of two-side printing in which an image is formed on both surfaces of the sheet of paper, the sheet of paper is fed to a return transport path BR by return transport rollers 52 and thus returns to an upstream side of the transport path R.

Since the front and back surfaces of the sheet of paper are reversed in the middle of transport on the return transport path BR, a surface that was previously a back surface becomes a new front surface. A position to which the sheet of paper is returned is a downstream side of the humidifier 60. The front surface of the sheet of paper returned to an upstream side of the transport path R through the return transport path BR has been dried by heat of the fixing unit 70, but moisture remains inside the sheet of paper. Therefore, the sheet of paper is not humidified again.

A combination of the return transport rollers 52 and the return transport path BR is an example of a returning unit according to the present disclosure.

The sheet of paper returned to the upstream side of the transport path R is fed to the register rollers 51 without passing the humidifier 60, and an image is transferred and fixed onto the new front surface in a procedure similar to that described above. The sheet of paper on which the image has been fixed is delivered to an outside of the printer 1.

In the second transfer unit 30 of the printer 1, a transfer voltage in which a direct-current component and an alternating-current component are superimposed on each other is used as a transfer voltage (transfer bias) for transferring an image. Hereinafter, such a transfer voltage containing an alternating-current component is sometimes referred to as an “alternating-current bias”.

A part from the humidifier 6 to the second transfer unit 30 of the printer 1 is an example of an exemplary embodiment of a transfer device according to the present disclosure.

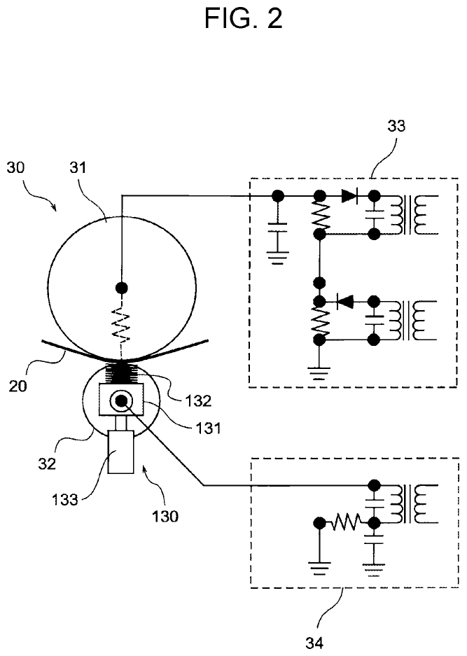

FIG. 2 illustrates a structure for applying a voltage to the second transfer unit 30.

In the present exemplary embodiment, for example, a direct-current voltage is applied from the front-surface side of the sheet of paper and an alternating-current voltage is applied from the back-surface side of the sheet of paper. That is, a direct-current power source 33 is connected to the backup roller 31, and a direct-current voltage is applied to the sheet of paper from the front-surface side of the sheet of paper through the backup roller 31 and the intermediate transfer belt 20.

Meanwhile, an alternating-current power source 34 is connected to the transfer roller 32, and an alternating-current voltage is applied to the sheet of paper from the back-surface side of the sheet of paper through the transfer roller 32. The alternating-current power source 34 is used in accordance with the kind of sheet of paper. For example, the alternating-current power source 34 is on in a case where the sheet of paper is a sheet of paper, such as embossed paper, having an uneven surface, and the alternating-current power source 34 is off in a case where the sheet of paper is a sheet of paper, such as plain paper or a cardboard, having a flat surface.

The second transfer unit 30 also includes a changing mechanism 130 that changes a pressure (transfer nip pressure) by which the sheet of paper is nipped by the backup roller 31 and the transfer roller 32. The changing mechanism 130 includes a shaft bearing 131 movable in a top-down direction in FIG. 2 relative to a frame (not illustrated) of the second transfer unit 30, and a rotary shaft of the transfer roller 32 is rotatably supported by the shaft bearing 131. Furthermore, the changing mechanism 130 includes a pressing spring 132 that presses the shaft bearing 131 from an upper side of FIG. 2 and an actuator 133 that pushes the shaft bearing 131 upward from a lower side of FIG. 2.

The actuator 133 is driven under control of the controller 80 (see FIG. 1) so that the shaft bearing 131 moves in the up-down direction in FIG. 2. When the shaft bearing 131 moves upward in FIG. 2, the transfer roller 32 approaches the backup roller 31. This increases the transfer nip pressure. When the shaft bearing 131 moves downward in FIG. 2, the transfer roller 32 is moved away from the backup roller 31. This decreases the transfer nip pressure.

The transfer nip pressure is switched in accordance with the kind of sheet of paper. For example, a transfer nip pressure for plain paper is higher than a transfer nip pressure for a cardboard. Furthermore, for example, a transfer nip pressure for embossed paper is lower than a transfer nip pressure for a cardboard and is equal to or higher than a transfer nip pressure for plain paper.

The second transfer unit 30 illustrated in FIG. 2 is an example of a transfer unit according to the present disclosure.

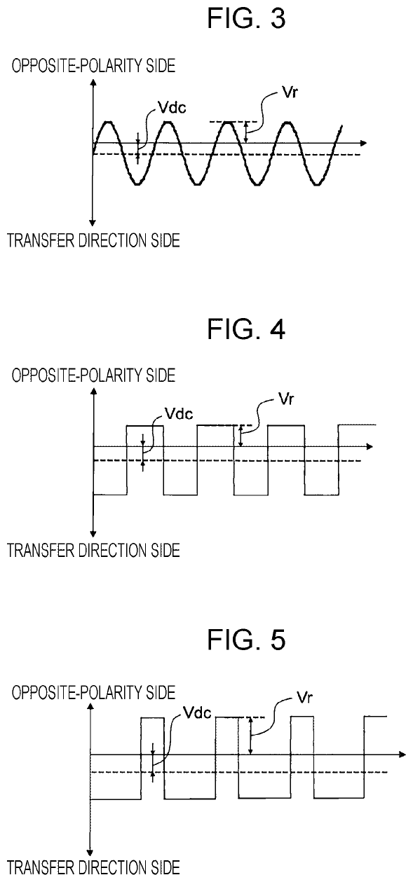

FIGS. 3 through 5 are graphs illustrating an example of a transfer voltage applied to the sheet of paper.

In each of the graphs, the horizontal axis represents time, and the vertical axis represents a voltage. A voltage below the horizontal axis of the graph is a voltage (positive-polarity voltage) of a polarity for transferring an image (toner of the image) onto the sheet of paper, and a voltage above the horizontal axis of the graph is a voltage (reverse-polarity voltage) of a polarity for returning toner from the sheet of paper to the intermediate transfer belt 20.

FIG. 3 illustrates a transfer voltage having a sinusoidal waveform.

Part of the voltage having a sinusoidal waveform is a reverse-polarity voltage, but large part of the sinusoidal voltage is a positive-polarity voltage. Since part of the sinusoidal voltage is a reverse-polarity voltage, part of transferred toner returns to the intermediate transfer belt 20 and collides with toner remaining on the intermediate transfer belt 20. This allows the toner on the intermediate transfer belt 20 to be easily detached from the intermediate transfer belt 20. This improves image transfer performance.

A direct-current component Vdc and a return component Vr in the waveform of the transfer voltage are described below. The direct-current component Vdc corresponds to an average voltage in the voltage waveform of the transfer voltage and represents average transfer power of the whole waveform of the transfer voltage. The return component Vr is a maximum value in a part on the reverse-polarity side of the waveform of the transfer voltage and represents an intensity of temporary return of toner.

FIG. 4 illustrates a transfer voltage having a rectangular waveform.

In the case of the rectangular wave illustrated in FIG. 4, a temporal ratio of a positive-polarity side voltage and a reverse-polarity side voltage is 1:1. However, since the positive-polarity side voltage is larger than the reverse-polarity side voltage, the whole transfer voltage acts to transfer an image.

FIG. 5 illustrates another example of a transfer voltage having a rectangular waveform.

In the case of the rectangular wave illustrated in FIG. 5, the positive-polarity side voltage and the reverse-polarity side voltage are equivalent to each other. However, a period of the positive-polarity side voltage is longer than a period of the reverse-polarity side voltage, and therefore the whole transfer voltage acts to transfer an image.

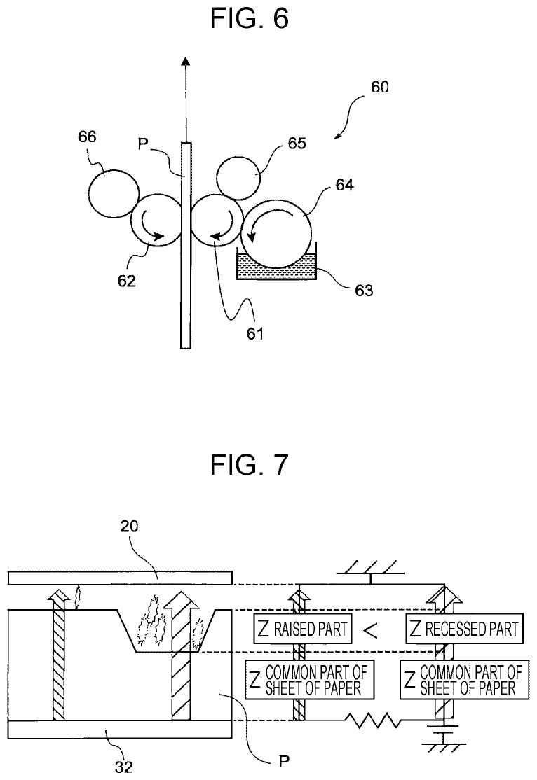

FIG. 6 illustrates a structure of the humidifier 60.

The humidifier 60 includes, for example, a pair of sponge rollers 61 and 62 that sandwich a sheet of paper P and a supply roller 64 that supplies water in a tank 63 to one sponge roller 61. Furthermore, the humidifier 60 also includes water-absorbing rollers 65 and 66 that absorb excess water from the sponge rollers 61 and 62. The humidifier 60 gives moisture to a back surface of the sheet of paper by using one sponge roller 61.

In the printer 1 illustrated in FIG. 1, an alternating-current bias and back-surface humidification are used in combination for embossed paper having an uneven surface. An effect of such combined use is described below.

FIG. 7 illustrates an effect obtained in a case where an alternating-current bias is used without back-surface humidification.

The left part of FIG. 7 illustrates the sheet of paper P sandwiched between the intermediate transfer belt 20 and the transfer roller 32, and the right part of FIG. 7 illustrates an electrical state of the sheet of paper P.

In a case where the sheet of paper P sandwiched between the intermediate transfer belt 20 and the transfer roller 32 is paper having large unevenness such as embossed paper, a raised part and a recessed part of the sheet of paper P have different thicknesses, and therefore an electrical path from the transfer roller 32 to the intermediate transfer belt 20 include an air layer in the recessed part. Accordingly, a path reaching to the intermediate transfer belt 20 through the recessed part has higher impedance than a path reaching to the intermediate transfer belt 20 through the raised part. This leads to a risk of application of a high voltage to the recessed part and occurrence of electric discharge. The electric discharge in the recessed part causes shortage of a transfer voltage, thereby causing defective transfer.

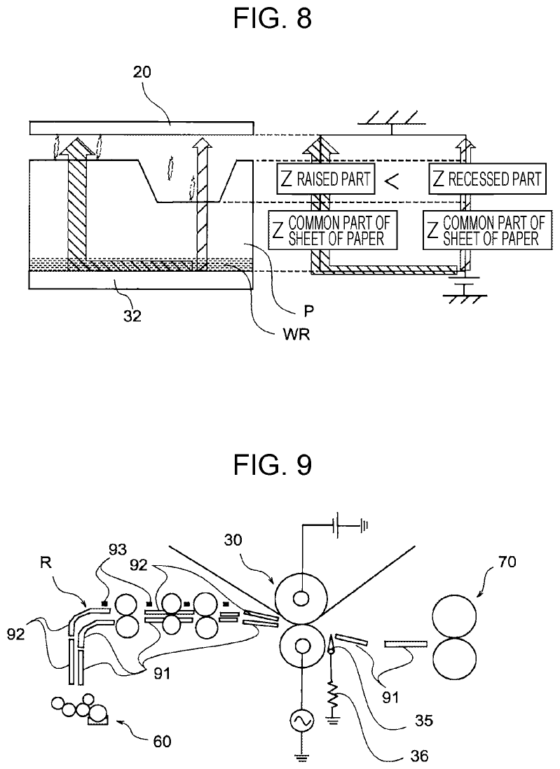

FIG. 8 illustrates an effect obtained in a case where back-surface humidification is performed and an alternating-current bias is used.

The left part of FIG. 8 illustrates the sheet of paper P sandwiched between the intermediate transfer belt 20 and the transfer roller 32, and the right side of FIG. 8 illustrates an electric state of the sheet of paper P.

In a case where back-surface humidification is performed, a humidification region WR is formed on a back surface of the sheet of paper P that is in contact with the transfer roller 32. Accordingly, in a case where a high voltage occurs in a path passing the recessed part, an electric current escapes to the raised part side through the humidification region WR. This avoids electric discharge in the recessed part, thereby obtaining a sufficient transfer voltage in the whole sheet of paper P.

The above effect produced by combined use of an alternating-current bias and back-surface humidification is inhibited in a case where an alternating current leaks through the sheet of paper. In view of this, in the present exemplary embodiment, a structure that prevents leakage of an alternating current is used.

FIG. 9 illustrates a structure of a transport path.

More specifically, the transport path R includes guide plates 91 and 92 that guide the sheet of paper while being in contact with respective surfaces of the sheet of paper. Of these guide plates 91 and 92, the back-surface guide plate 91 located on a lower side in FIG. 9 is in contact with the back surface of the sheet of paper, and the front-surface guide plate 92 located on an upper side in FIG. 9 is in contact with the front surface of the sheet of paper. In order to prevent leakage of an alternating-current voltage through the sheet of paper, these guide plates 91 and 92 are made of a resin in a range larger than a longest size of the sheet of paper in a paper transport direction. Since leakage of an alternating current is easier to occur on the humidified back-surface side than on the front-surface side, it is especially desirable that the back-surface guide plate 91 that is in contact with the back-surface side of the sheet of paper be made of a resin, and the front-surface guide plate 92 may be made of a metal. These guide plates 91 and 92 are an example of a guide unit according to the present disclosure.

The back-surface guide plate 91 on the transport path R from the transfer unit 30 to the fixing unit 70 is also made of a resin.

Furthermore, the transfer unit 30 includes an eliminating member 35 that makes contact with the sheet of paper after transfer and allows an electric charge to escape. In order to suppress electric current leakage from the eliminating member 35, the eliminating member 35 is grounded via a high-resistance resistor 35.

The humidifier 60 is provided so that a distance from the transfer unit 30 along the transport path R is longer than the longest size of the sheet of paper in the transport direction. This avoids electric current leakage caused by contact of the sheet of paper with both of the transfer unit 30 and the humidifier 60.

The transport path R is provided with plural sensors 93 that detect the sheet of paper transported on the transport path R. These sensors 93 are, for example, reflection-type optical sensors. When the sheet of paper on the transport path R reaches a position in front of each of the sensors 93, the sensor 93 receives light reflected by the sheet of paper and detects presence of the sheet of paper. The sensors 93 are provided so as to face the front-surface side of the sheet of paper. Even in a case where electric current leakage occurs accidentally, this achieves higher safety than in a case where the sensors 93 are provided so as to face the back-surface side of the sheet of paper.

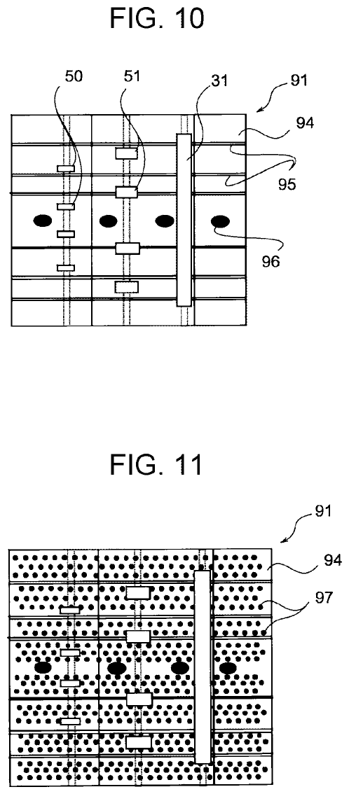

FIG. 10 illustrates a detailed structure of the back-surface guide plate 91.

FIG. 10 illustrates a state (a state viewed from the upper side in FIG. 9) where the back-surface guide plate 91 is viewed from the paper side.

The back-surface guide plate 91 has a body 94 having a plate shape and a rib 95 that protrudes from the body toward the sheet of paper and extends linearly in the paper transport direction (rightward in FIG. 10). The rib 95 reduces a contact area between the back-surface guide plate 91 and the sheet of paper as compared with a case where the rib 95 is not provided, thereby further suppressing leakage of an alternating current.

The back-surface guide plate 91 has, in the body 94, a hole 96 through which light from the sensors 93 passes in a case where there is no sheet of paper. Furthermore, the body 94 of the back-surface guide plate 91 has through holes through which the transport roller 50, the register roller 51, and the transfer roller 32 make contact with the sheet of paper through the body 94. Since the transport roller 50 and the register roller 51 are rubber rollers, it is considered that leakage of an alternating current through the transport roller 50 and the register roller 51 is small. However, electric current leakage suppression may also be performed on the transport roller 50 and the register roller 51 as described later.

The blower fan 55 blows air from the upper side to the lower side in FIG. 10. This flow of air reduces moisture on surfaces of the back-surface guide plate 91, the transport roller 50, the register roller 51, and the like and thereby prompts drying. This further suppresses electric current leakage.

Since leakage of an electric current through the sheet of paper is suppressed in the printer 1 according to the present exemplary embodiment as described above, transfer performance is improved by combined use of back-surface humidification and an alternating-current bias.

Next, a modification of the above exemplary embodiment is described.

FIG. 11 illustrates a modification of the back-surface guide plate 91.

A back-surface guide plate 91 according to the modification illustrated in FIG. 11 has through holes 97 throughout the body 94. These through holes 97 are for promptly reducing humidity on an opposing surface of the body 94 that faces the back surface of the sheet of paper. The through holes 97 promptly reduces humidity on the opposing surface as compared with a case where no through hole 97 is provided. Furthermore, combined use of the blower fan 55 with the through holes 97 more promptly reduces humidity.

The reduction in humidity on the opposing surface of the back-surface guide plate 91 further suppresses leakage of an alternating current.

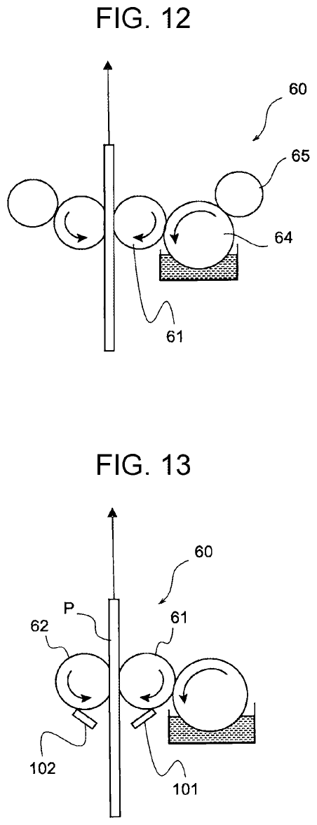

FIG. 12 illustrates a modification of the humidifier 60.

A humidifier 60 according to the modification illustrated in FIG. 12 is configured such that the water-absorbing roller 65 is in contact with the supply roller 64 and absorbs excess water from the surface of the supply roller 64 before contact with the sponge roller 61. In this way, a right amount of water is kept on the sponge roller 61.

FIG. 13 illustrates another modification of the humidifier 60.

A humidifier 60 according to the modification illustrated in FIG. 13 includes blades 101 and 102 instead of water absorbing rollers. These blades 101 and 102 scrape excess water off from the sponge rollers 61 and 62.

Although the humidifiers 60 illustrated in FIGS. 6, 12, and 13 are contact-type humidifiers, the humidifier according to the present disclosure may be a non-contact-type humidifier that gives moisture to the sheet of paper P in a non-contact manner.

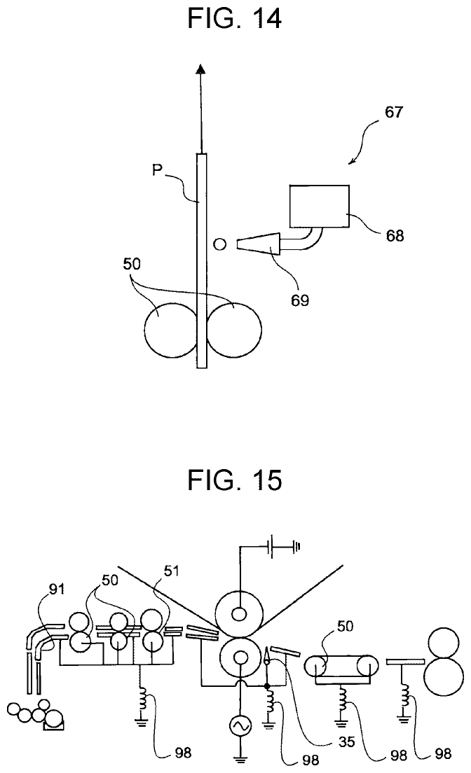

FIG. 14 illustrates a non-contact-type humidifier 67.

The non-contact-type humidifier 67 includes a water tank 68 and a nozzle 69. The humidifier 67 ejects, from the nozzle 69, water supplied from the water tank 68 toward the back surface of the sheet of paper P that is transported in a direction indicated by the arrow in FIG. 14 by the transport rollers 50 according to an inkjet method.

In a case where such a non-contact-type humidifier 67 is used in the printer 1 instead of the contact-type humidifier 60, a distance between the humidifier 67 and the transfer roller 32 may be shorter than the longest size since the non-contact-type humidifier 67 is not in contact with the sheet of paper. Accordingly, the non-contact-type humidifier 67 contributes to a reduction in size of the printer 1.

FIG. 15 illustrates a modification that is different in terms of a measure for suppressing leakage of an alternating current.

In the modification illustrated in FIG. 15, the back-surface guide plate 91 is grounded via an inductor 98 instead of the configuration in which the guide plates 91 and 92 are made of a resin or in addition to the configuration in which the guide plates 91 and 92 are made of a resin. Furthermore, the transport rollers 50, the register rollers 51, and the eliminating member 35 are also grounded via the inductor 98. The inductor 98 generates high impedance to an alternating-current voltage and therefore suppresses leakage of an alternating current. A high-resistance element may be employed as an element that generates impedance for suppressing leakage of an alternating current.

FIG. 16 illustrates another modification that is different in terms of a measure for suppressing leakage of an alternating current.

In the modification illustrated in FIG. 16, the back-surface guide plate 91 is grounded via a switch 99 instead of the configuration in which the guide plates 91 and 92 are made of a resin or in addition to the configuration in which the guide plates 91 and 92 are made of a resin. Furthermore, the transport rollers 50, the register rollers 51, and the eliminating member 35 are also grounded via the switch 99. Opening and closing of each switch 99 are switched under control of the controller 80. In a case where an alternating-current bias is used, each switch 99 is opened so that leakage of an alternating current is suppressed. In a case where a direct-current transfer voltage is used, each switch 99 is closed so that occurrence of static electricity and the like is suppressed.

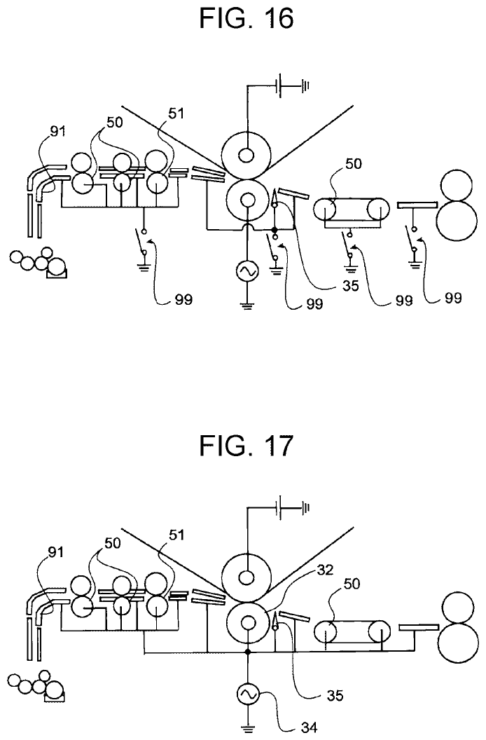

FIG. 17 illustrates still another modification that is different in terms of a measure for suppressing leakage of an alternating current.

In the modification illustrated in FIG. 17, the back-surface guide plate 91 is connected to the alternating-current power source 34 instead of the configuration in which the guide plates 91 and 92 are made of a resin or in addition to the configuration in which the guide plates 91 and 92 are made of a resin. Furthermore, the transport rollers 50, the register rollers 51, and the eliminating member 35 are also connected to the alternating-current power source 34. Since the back-surface guide plate 91, the transport rollers 50, the register rollers 51, and the eliminating member 35 are connected to the alternating-current power source 34, an alternating current of a phase identical to the transfer roller 32 is applied to the back-surface guide plate 91, the transport rollers 50, the register rollers 51, and the eliminating member 35.

In the case where an alternating current of a phase identical to the transfer roller 32 is applied to the members such as the back-surface guide plate 91, a potential difference between the transfer roller 32 and the members such as the back-surface guide plate 91 is suppressed, and therefore leakage of an alternating current is suppressed.

Although an indirect-transfer-type color printer using an intermediate transfer belt is illustrated in the above description, the image forming apparatus according to the present disclosure may be a black-and-white printer or may be a direct-transfer-type printer. In a case where the image forming apparatus according to the present disclosure is a direct-transfer-type printer, a photo conductor is an example of an image carrier according to the present disclosure.

Although a printer is illustrated as an exemplary embodiment of the image forming apparatus according to the present disclosure in the above description, the image forming apparatus according to the present disclosure may be a copying machine, may be a fax machine, or may be a multifunction printer.

Although an electrophotographic image engine is illustrated in the above description, an image forming unit according to the present disclosure may form a toner image according to a system other than an electrophotographic system.

Although the present disclosure has been made for the purpose of solving the problem described in Summary, the configuration of the present disclosure may be used for a different purpose without solving this problem, and such a form in which the configuration of the present disclosure is used for a different purpose is also an exemplary embodiment of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A transfer device comprising:
a transfer unit that transfers an image on an image carrier carrying the image onto a recording material by applying a voltage containing an alternating-current component to the recording material;
a humidifying unit that humidifies the recording material transported toward the transfer unit;
a transport unit that transports the recording material from the humidifying unit to the transfer unit while guiding the recording material in contact with a guide unit; and
a leakage suppressing unit that suppresses leakage of an alternating current of the alternating-current component to the guide unit throughout a maximum length or more of the recording material in a direction in which the recording material is transported.

2. The transfer device according to claim 1, wherein
the humidifying unit humidifies the recording material from a second surface of the recording material that is opposite to a first surface onto which an image is to be transferred;
the transfer unit applies at least the alternating-current component from the second surface side; and
the leakage suppressing unit suppresses leakage of an alternating current of the alternating-current component in at least part of the guide unit that is in contact with the second surface.

3. The transfer device according to claim 2, further comprising a detection unit that detects the recording material from the first surface side.

4. The transfer device according to claim 1, wherein
the leakage suppressing unit is constituted by the guide unit made of a resin.

5. The transfer device according to claim 4, wherein
the guide unit has a linear protrusion that extends in the direction in which the recording material is transported, and the linear protrusion makes contact with the recording material.

6. The transfer device according to claim 1, wherein
the leakage suppressing unit is configured such that the guide unit is grounded via an element having impedance that suppresses leakage of an alternating current of the alternating-current component.

7. The transfer device according to claim 6, wherein
the leakage suppressing unit is configured such that the guide unit is grounded via an inductor.

8. The transfer device according to claim 1, wherein
the leakage suppressing unit is configured such that the guide unit is grounded via a switch that is turned off in a case where the alternating-current component is applied.

9. The transfer device according to claim 1, wherein
the leakage suppressing unit is configured such that an alternating-current voltage of a phase identical to the alternating-current component is applied to the guide unit.

10. The transfer device according to claim 2, wherein
the leakage suppressing unit also suppresses leakage of the alternating current in a part of the guide unit that makes contact with the first surface.

11. The transfer device according to claim 1, wherein
the humidifying unit humidifies the recording material while being in contact with the recording material at a position away from the transfer unit by longer than the maximum length along a transport path for the recording material.

12. The transfer device according to claim 1, further comprising an air blower that blows air to the guide unit.

13. The transfer device according to claim 1, wherein
the guide unit has a through hole through which moisture escapes from a transport path for the recording material.

14. An image forming apparatus comprising:
an image carrier that carries an image on a surface thereof;
an image forming unit that forms the image on the image carrier;
a transfer unit that transfers the image on the image carrier onto a recording material by applying a voltage containing an alternating-current component to the recording material;
a humidifying unit that humidifies the recording material transported toward the transfer unit;
a transport unit that transports the recording material from the humidifying unit to the transfer unit while guiding the recording material in contact with a guide unit;
a leakage suppressing unit that suppresses leakage of an alternating current of the alternating-current component to the guide unit throughout a maximum length or more of the recording material in a direction in which the recording material is transported; and
a fixing unit that fixes, onto the recording material, the image transferred onto the recording material.

15. A transfer device comprising:
transfer means for transferring an image on an image carrier carrying the image onto a recording material by applying a voltage containing an alternating-current component to the recording material;
humidifying means for humidifying the recording material transported toward the transfer unit;
transport means for transporting the recording material from the humidifying unit to the transfer unit while guiding the recording material in contact with a guide unit; and
leakage suppressing means for suppressing leakage of an alternating current of the alternating-current component to the guide unit throughout a maximum length or more of the recording material in a direction in which the recording material is transported.
